(19) United States
(12) Patent Application Publication
(10) Pub. No.: US 2009/0076222 A1
(43) Pub. Date: Mar. 19, 2009

(54) CLEAR FUNCTIONAL COATING FOR ELASTOMERS

(76) Inventor: David R. Pugne, Fairview, PA (US)

Correspondence Address: LORD CORPORATION;PATENT & LEGAL SERVICES, 111 LORD DRIVE, P.O. Box 8012, CARY, NC, 27512-8012, US

(21) Appl. No.: 12/208,723

(22) Filed: Sep. 11, 2008

Related U.S. Application Data
(60) Provisional application No. 60/972,443, filed on Sep. 14, 2007.

(51) Int. Cl. C08L 75/06; C08L 75/04

(52) U.S. Cl. 525/123; 525/418

(57) ABSTRACT

A coating composition comprising a polycarbonate-based polyurethane, and a polyester-based polyurethane, which is substantially free of siloxane compounds, wherein when the coating composition is applied to a substrate, dried, and crosslinked, it has a delta E of less than 3.0 after exposure to 1240kJ/m2 of ultraviolet light. In a more preferred embodiment of the present invention, the delta E is less than 2.0.

### CROSS REFERENCE TO RELATED APPLICATIONS

The present application claims priority under 35 U.S.C. § 119(e) from U.S. Provisional Patent Application Ser. No. 60/972,443 filed Sep. 14, 2007, entitled “COLORLESS FUNCTIONAL COATING FOR ELASTOMERS”, the disclosure of which is incorporated herein by reference.

### FIELD OF THE INVENTION

The present invention relates to a clear aqueous composition that when applied as a coating to a rubber or polymer substrate such as a vehicle weatherstrip reduces the amount of noise of the substrate upon contact with an article and maintains the initial static coefficient of friction therewith over a period of time.

### BACKGROUND OF THE INVENTION

In the automotive weatherstrip industry, functional coatings are typically applied to various seals. The purpose of these coatings is to provide properties such as ice release and reduced noise while also being resistant to certain cleaning chemicals, having good weathering properties, good flexibility, and acceptable appearance. The coatings which provide these properties, within the automotive weatherstrip market, have almost exclusively been pigmented black in order to meet the color requirements of the OEMs. However, there has been some interest in the automotive industry to begin matching the color of the interior portion of co-extruded door seals to that of the vehicles' interiors. Therefore, a profile consisting of a traditional black, sponge EPDM seal along with a colored dense EPDM needs to be produced. In order to apply the standard black functional coatings to this type of profile, it would require the colored portion to be masked. Therefore, it would be preferred by the weatherstrip manufacturer to apply a colorless coating to the entire profile.

It is therefore desirable to have the functional performance of traditional coatings such as Autoseal® 3131 coating (manufactured by LORD Corporation), but in a clear coating. However, merely removing the pigment from a coating such as Autoseal 3131 does not result in a coating with acceptable appearance and flexibility. Furthermore, when subjected to weatherability testing, the resultant coating exhibited an unacceptably high delta E and the coating often cracked or produced lines when flexed.

### SUMMARY OF THE INVENTION

In a first aspect of the present invention, an aqueous, colorless, functional coating is provided which is particularly useful for coating elastomers such as EPDM profiles in the automotive weatherstrip market. This coating is able to provide the functional performance properties of a typical black coating while maintaining a certain degree of clarity, defined as a delta E below 3.0 and preferably below 2.0 in comparison to the uncoated profile. The coating in an embodiment of the present invention also provides the benefit of reducing squeak and has utility as a “low noise” coating.

In one aspect of the present invention, a coating composition is provided comprising a polycarbonate-based polyurethane, and a polyester-based polyurethane, which is substantially free of siloxane compounds, wherein when the coating composition is applied to a substrate, dried, and crosslinked, it has a delta E of less than 3.0 after exposure to 1240 kJ/m2 of ultraviolet light. In a more preferred embodiment of the present invention, the delta E is less than 2.0.

In one embodiment of the present invention, the coating composition further comprises a polyethylene wax, and most preferably a polyethylene wax having an average particle size of less than 20 μm.

In further embodiments of the present invention, the coating composition further comprises one or more of ceramic spheres, and/or a surfactant, wherein a preferred surfactant comprises a fluoro surfactant.

In an additional aspect of the present invention, the polycarbonate-based polyurethane comprises the reaction product of poly(1,6-hexanediol)carbonate, polyethylene glycol and isophorone diisocyanate.

In a still further embodiment of the present invention, the coating is crosslinked with a carbodiamide crosslinker, preferably at about 2.5 weight percent based on the weight of the coating composition.

In another embodiment of the present invention, the coating is applied to a substrate to a thickness of less than 0.6 mils. In an additional embodiment of the present invention, the substrate comprises EPDM.

In a further aspect of the present invention, a coating composition is provided consisting essentially of a polycarbonate-based polyurethane, a polyester-based polyurethane, a polyethylene wax, fumed silica, ceramic spheres, and a surfactant.

In a still further aspect of the present invention, an article coated with an aqueous polyurethane coating is provided, wherein the dried coating comprises, 30-80 weight percent of a polyurethane mixture comprising at least one polycarbonate-based polyurethane and at least one polyester-based polyurethane, 0.1-10 weight percent fumed silica, 0.1-30 weight percent ceramic spheres having an average particle size of less than 20 μm, 0.1 to 15 weight percent polyethylene wax, 0.1 to 5.0 weight percent of a surfactant, 0.1 to 5.0 weight percent of a UV absorber, and 0 to 5.0 weight percent of a thickener.

In one aspect of the present invention, the coatings are particularly useful for vehicular weatherstrip applications. They may be used as a functional coating for co-extruded profiles in which 2 different compound colors are used. This prevents the need to mask the portion of the co-extrusion that was not desired to be coated (due to the prior art coatings being black). Additionally, they may be used as a general purpose functional coating that can be used for all OEM weatherstrip seal applications due to their level of clarity (assuming the rubber is already color matched). This allows the weatherstrip manufacturer to inventory only one coating. The coatings of the present invention also have utility as a smooth, untextured, “low noise” weatherstrip coating.

As will be realized by those of skill in the art, many different embodiments of a colorless functional coating according to the present invention are possible. Additional uses, objects, advantages, and novel features of the invention are set forth in the detailed description that follows and will become more apparent to those skilled in the art upon examination of the following or by practice of the invention.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION OF THE PREFERRED EMBODIMENTS

In a first embodiment of the present invention, a clear coating composition is provided comprising a polycarbonate-based polyurethane, and a polyester-based polyurethane, which is substantially free of siloxane compounds. The coating is defined as being clear as when the coating composition is applied to a substrate, dried, and crosslinked, it has a delta E of less than 3.0 after exposure to 1240 kJ/m2 of ultraviolet light. It is desirable to provide a coating which is substantially free of siloxane compounds as these have been found to cause undesirable graying of the otherwise clear coating.

In one embodiment of the present invention, the polyurethane comprises a polycarbonate based polyurethane. Such polyurethanes are commercially available and are derived from one or more polyisocyanates and one or more hydroxyl terminated intermediates such as polycarbonate intermediates.

The polycarbonates, also referred to as dimer diol carbonates, are known to the art and to the literature and are linked together by carbonate groups, i.e.:

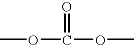

and contain one or more hydrocarbon groups having from about 1 to about 20 carbon atoms, with Bisphenol A being a very common and desired group. Desirably the polycarbonate is prepared from one or more aromatic diols such as bisphenol A, tetrabromo bisphenol A, tetramethyl bisphenol A, 1,1-bis(4-hydroxyphenyl)-1-phenylethane, 3,3-bis(para-hydroxyphenyl) phthalide, or bishydroxyphenylfluorene. The polycarbonates can be prepared from raw materials by any of several known processes such as interfacial, solution or melt processes. As is well known, suitable chain terminators and/or branching agents can be employed to obtain the desired molecular weights and branching degrees. The polycarbonate can be derived from two or more different aromatic diols, or an aromatic diol and a glycol, or a hydroxyl- or acid-terminated polyester, or a dibasic acid in the event a polycarbonate copolymer or heteropolymer is desired rather than a homopolymer.

In a preferred embodiment of the present invention, the polycarbonate comprises poly(1,6-hexanediol)carbonate. Such polycarbonates are prepared by condensation of phosgene or alkylene glycol carbonates, e.g., dimethyl carbonate, with alkylene glycols such as 1,6-hexanediol.

The hydroxyl terminated polyurethane intermediates of the present invention can also contain other hydrophilic groups in order to improve the dispersion of the polyurethane in water. Such hydrophilic groups are generally pendant from the backbone chain and include hydroxyl groups, carboxyl groups, and the like and can be crosslinked and result in cure of the urethane. Examples of hydroxyl groups are well known and include the glycols set forth hereinabove with regard to the formation of the polyester intermediate which are hereby fully incorporated by reference. Examples of carboxyl groups are also known to the art and to the literature and can include hydroxy-carboxylic acids having the general formula (HO)x Q(COOH)y, wherein Q is a straight or branched hydrocarbon radical containing 1 to 12 carbon atoms, and x and y, independently, are 1 to 3. Examples of such hydroxy-carboxylic acids include, but are not limited to, citric acid, dimethylolpropanoic acid (DMPA), dimethylol butanoic acid (DMBA), glycolic acid, lactic acid, malic acid, dihydroxymalic acid, dihydroxytartaric acid, and the like, and mixtures thereof.

The various isocyanates that are reacted with the one or more hydroxyl terminated intermediates are preferably an aliphatic or a cycloaliphatic diisocyanate to impart good weatherability to the polyurethane. Examples of such suitable diisocyanates having from 4 to about 20 carbon atoms include dicyclohexylmethane 4,4′-diisocyanate (H12MDI) 3,5,5-trimethyl-1-isocyanato-3-isocyanatomethylcyclohexane (isophorone diisocyanate) or IPDI), tetramethylene diisocyanate, 1,3-bis(isocyanatomethyl)cyclohexane, hexamethylene diisocyanate (HDI), and dodecamethylene diisocyanate. Of course, if a tri- or a tetra-isocyanate is utilized, it will result in crosslinking of the polyurethane.

In a further embodiment of the present invention, the polyester polyurethanes are typically prepared by reacting isocyanate-functional urethane polyester prepolymers with low molecular weight chain extending diols employing conventional techniques well known in the art. An extensive description of some of the useful techniques for preparing polyester urethane prepolymers can be found in Saunders and Frisch: “Polyurethanes, Chemistry and Technology,” Part II, Interscience, (New York 1964), especially at pages 8 to 49, and in the references cited therein. Other preparative techniques which are known in the art can also be employed.

More specifically, the polyester polyurethanes which can be employed in the compositions of the present invention typically are prepared by reacting at least one polyester having two active hydrogen atoms with a diisocyanate in order to form an isocyanate-functional urethane polyester prepolymer. The urethane polyester prepolymer is then reacted with a low molecular weight chain extending diol in order to prepare the polyester polyurethane.

The formation of the polyurethanes utilized in the present invention are well known to the art and to the literature and are commercially available as is the preparation thereof. Thus, reaction is usually carried out in an organic solvent such as methyl ethyl ketone, or n-methylpyrrolidone, and the like. Neutralizing agents are desirably added to render the polyurethane more water compatible. Neutralizing agents include amines such as N-methyl morpholine, triethylamine, dimethyl ethanolamine, methyl diethanolamine, morpholine dimethyl isopropanolamine, 2-amino-2-methyl-1-propanol, and the like, and mixtures thereof. Chain extension is usually desired and while various diols can be utilized, diamines having a total of from about 2 to about 20 carbon atoms are desired. Examples include ethylendiamine, 1,6-diaminohexane, piperazine, tris(2-aminoethyl)amine and amine tertinated polyethers, and mixtures thereof, and the like. Water is generally added after neutralization. Subsequently, the organic solvent can be removed through various known techniques such as evaporation, utilization of extraction techniques, and the like with the result being a high molecular weight aqueous polyurethane.

The number average molecular weight of polyurethanes of the present invention generally range from about 50,000 to about 500,000 with about 100,000 to about 300,000 being preferred. The amount of urethane solids in water is generally from about 20 percent to about 60 percent by weight and desirably from about 35 percent to about 50 percent by weight. In a preferred embodiment of the present invention, the coating comprises a polycarbonate-based polyurethane dispersion with substantially no additional urethanes added thereby achieving weathering properties and chemical resistance without the need for a mixture of different urethanes.

The amount of the one or more polyurethanes, per se, that is the total polymer(s) (100% solids and no water) utilized in the aqueous dispersion compositions of the present invention is generally from about 15 percent to about 50 percent by weight, desirably from about 20 percent to about 45 percent by weight, and preferably from about 25 percent to about 40 percent by weight based upon the total weight of the total composition.

In a further aspect of the present invention, an inorganic filler is provided having a critical particle size range to enhance scratch resistance, reduce gloss and provide matting in the coating, while not interfering with the transparency of the cured coating. In a preferred embodiment of the present invention, the inorganic filler comprises aluminum oxide, silicon dioxide, ceramic spheres or mixtures thereof.

In a preferred embodiment of the present invention, the inorganic filler comprises ceramic spheres of which those naturally occurring or synthetically produced such that the composition may be from about 50 to about 99 percent by weight silicon dioxide and 0 to about 30 percent aluminum oxide, as the key components, and contain sodium oxide from 0 to about 11 percent, potassium oxide from 0 to about 6 percent, carbon from 0 to about 3 percent and/or calcium oxide, ferric oxide, magnesium oxide, titanium oxide, sulfur trioxide in quantities from 0 to about 2 percent.

In a preferred embodiment of the present invention, the ceramic spheres comprise silica and alumina or alkali alumino silicate ceramic. Such products can be obtained commercially including 3M® Zeeospheres® ceramic microspheres. Especially preferred ceramic spheres are those identified by 3M® as G-200, W-210, and W-410. These fillers have the added benefit of providing some gloss reduction to the finished coating. In one embodiment of the present invention the 50th percentile particle size comprises 5-15 microns. In a preferred embodiment of the present invention, the 50th percentile particle size comprises 10-12 microns.

In another preferred embodiment of the present invention, 3 micron silicon dioxide is added as a matting agent in an amount from about from 0.1 to about 1.0 percent by weight based on the total weight of the aqueous composition. In another embodiment of the present invention, the fumed silica comprises 0.1 to 10 weight percent of the dried composition (i.e. water and solvent free).

Generally, the total inorganic filler material of the invention will be used in an amount sufficient to provide the desired physical characteristics to the coating. This amount generally will be about 1 to about 8 percent by weight of the total coating composition, with the preferable amount being about 1.5 to about 4 percent by weight of the total composition. While the preferable amount of the inorganic particles in a typical formulation is 1 to 8 percent by weight, amounts up to and greater than 25 percent also exhibit excellent scratch resistant properties. The effects of higher levels of inorganic particles incorporated beyond 25 percent by weight are, increased viscosity of the coating prior to application, settling of the filler particles, incidence of unwanted coating texture, and detrimental effect on physical properties and including an increased tendency for producing white marks when the coating is gouged. Similarly, inorganic particles incorporated at a total level less than 1 percent by weight often fail to achieve the improved scratch resistance.

In a further embodiment of the present invention, a particle wax is added to enhance slip properties and improve squeak performance. Particle waxes of the present invention can be selected from any of the known classes of waxes, i.e. vegetable waxes, animal waxes, mineral waxes, petroleum waxes, synthetic waxes, and the like.

In a preferred embodiment of the present invention, thermoplastic waxes are employed except those with melting points above the coating processing temperatures. Example of thermoplastic waxes include, one or more polyolefins and preferably polyethylenes such as powdered crystalline high temperature resistant polyethylenes since they lower both the dry and wet noise level when applied to a vehicle seal such as an automobile weatherstrip. Such polyethylenes are commercially available and thus known to the art and to the literature

The weight average molecular weight of the preferred polyethylene is generally very high and ranges from about 2 million to about 5 million and desirably from about 3 million to about 4 million and thus can be classified as an ultra high molecular weight polyethylene.

It has been discovered that smaller particle sizes are best so as not to interfere with the clarity of the coating and enhance viscosity. In one embodiment of the present invention, the wax particle has a D50 of about 7 microns and a D90 of about 15 microns. In another preferred embodiment of the present invention, the wax particle has a melting point of about 200° F.

In one embodiment of the present invention, the particle wax is present in an amount from about 1 to about 5 weight percent, based on the total weight of the wet coating. In a further embodiment of the present invention, the particle wax is present in an amount from about 2 to about 4 weight percent, based on the total weight of the wet coating. In another embodiment of the present invention, the polyethylene wax comprises 0.1 to 15 weight percent of the dried composition (i.e. water and solvent free).

In another embodiment of the present invention, a surfactant is employed to enhance wetting of the substrate. In a preferred embodiment of the present invention, a fluorinated surfactant is employed. Such fluorinated surfactants are generally anionic surfactants having one or more fluorine atoms incorporated into either into the backbone of the surfactant or as a branched substituent.

Among the useful fluorinated surfactants are those which correspond to the formula:

CF3*CF2(CF2CF2)n(CH2)nX

wherein n is an integer ranging from 1 to about 9, y is an integer ranging from 0 to about 5 and X is an anionic radical, which may be selected from the group consisting of sulfate, sulfonate, phosphate, phosphonate, ammonium, thiosulfate, thiosulfonate, and the like, as well as mixtures thereof.

In a most preferred embodiment of the present invention, the surfactant comprises a perfluorinated anionic functional compound comprising about a 50:50 weight mixture blend of a linear C4 to C14 perfluoro alkyl ethyl phosphonate acid and a perfluoro alkyl ethyl phosphonic acid surfactant.

When employed, the surfactant will generally comprise from about 0.05 percent to about 2.0 percent by weight of the wet composition and, preferably, from about 0.1 percent to about 1.0 percent by weight of the wet composition. In another embodiment of the present invention, the surfactant, when employed, comprises 0.1 to 5 weight percent of the dried composition (i.e. water and solvent free).

In a further embodiment of the present invention, a UV absorber and or hindered amine light stabilizer (HALS) is employed. In an embodiment of the present invention, the UV absorber and/or HALS comprises 0.1 to 5 weight percent of the dried composition (i.e. water and solvent free).

Various other additives such as additional fillers, gloss control agents, pigments, rheology modifiers, and the like can be used to impart various properties to the aqueous dispersion coating composition and/or the cured coating thereof.

The polycarbonate and polyester-based polyurethanes of the present invention can be crosslinked after the aqueous dispersion composition has been applied to a substrate. By crosslinking or curing it is meant that an individual polyurethane chain is chemically bound to at least one, preferably at least two other different polyurethane chains at a point other than their terminus. A preferred crosslinking mechanism of the present invention is through one or more pendant carboxylic acid groups of the polyurethane. Suitable crosslinking agents include various carbodiimides that are known to the art and to the literature. Alternatively, various aziridines can be utilized which have two or more aziridine groups thereon such as trimethylolpropane-tris-(B-(N-Aziridinyl)Propionate), and Pentaerythritol-tris-(B-(N-Aziridinyl)Propionate). Carbodiimide and polyaziridine crosslinking agents are desired and are curable at temperatures from about 50° C. to about 200° C. and desirably from about 80° C. to about 190° C. in relatively short periods of time as from about 2 to about 30 minutes. Naturally, the crosslinking reaction should not be carried out until the aqueous dispersion composition has been applied to an end substrate. The amount of cross linker generally ranges from about 0.5% to about 10% and desirably from about 1% to about 5% by weight based upon the total weight of the polycarbonate-based polyurethane dispersion composition.

### EXAMPLES

The following two formulations involve a polycarbonate-based polyurethane dispersion which is included for its weathering properties and chemical resistance. There is also a polyester-based polyurethane dispersion added for additional flexibility. Fumed silica is added as a matting agent, and the Zeeospheres are added as a low-cost filler and for some gloss reduction. A polyethylene wax powder is added for slip properties and itch & squeak performance. A defoamer is added to control foaming, and a wetting agent is added to enhance wet-out and to provide slip properties. A UV-absorber/HALS dispersion is added for stability of the dried coating when exposed to UV light. A thickener is added for viscosity control. A co-solvent is added for application/flash properties.

### Mixing Procedure:

1) In an 8 oz jar, add the polyurethane dispersions. Begin stirring under agitator at low speed.
2) Add ½ the amount of Fluoro Surfactant
3) Add the fumed silica and adjust mixing speed and blade location to facilitate dispersion of the powder.
4) Add the Zeeospheres
5) Add the wax (adjust mixing speed/blade location to facilitate dispersion)
6) Allow to mix for 10 minutes with the “doughnut” effect.
7) Add the deionized water.
8) Add the other ½ of Fluoro Surfactant
9) Add the Urethane Thickener
10) Allow the coating to mix at low speed for about 5 minutes.

### Formulation A

| | Wet | Wt % | |
|---|---|---|---|
| Material | pph | Solids | Solids |
| Polycarbonate-based | 30.65 | 39.0 | 11.95 |
| polyurethane | | | |
| Polyester based | 35.16 | 34.0 | 11.96 |
| polyurethane | | | |
| Fumed Silica | 1.88 | 100.0 | 1.88 |
| Zeeospheres (10-12 um) | 2.35 | 100.0 | 2.35 |
| Polyethylene wax | 2.50 | 100.0 | 2.50 |
| Defoamer | 0.10 | 96.0 | 0.10 |
| Fluoro Surfactant | 0.94 | 97.0 | 0.91 |
| DI Water | 18.80 | 0.0 | 0.00 |
| m-pyrrolidone | 5.64 | 0.0 | 0.00 |
| UV Absorber/HALS | 1.49 | 52.0 | 0.78 |
| dispersion | | | |
| Thickener | 0.47 | 25.0 | 0.12 |
| Total | 100.00 | | 32.55 |

### Formulation B

| | Wet | Wt % | |
|---|---|---|---|
| Material | pph | Solids | Solids |
| Polycarbonate-based | 29.75 | 39.0 | 11.60 |
| polyurethane | | | |
| Polyester-based | 34.13 | 34.0 | 11.61 |
| polyurethane | | | |
| Fumed silica | 0.46 | 100.0 | 0.46 |
| Zeeospheres (10-12 um) | 6.50 | 100.0 | 6.50 |
| Polyethylene wax | 2.51 | 100.0 | 2.51 |
| defoamer | 0.10 | 96.0 | 0.10 |
| Fluoro Surfactant | 0.91 | 97.0 | 0.89 |
| DI Water | 18.25 | 0.0 | 0.00 |
| m-pyrrolidone | 5.48 | 0.0 | 0.00 |
| UV-Absorber/HALS | 1.45 | 52.0 | 0.75 |
| dispersion | | | |
| Thickener | 0.46 | 25.0 | 0.11 |
| Total | 100.00 | | 34.52 |

### Performance

In all of the testing that has been performed, the prototype coatings have been crosslinked with 2.5 weight percent, based on the weight of the coating formulation, of a carbodiamide crosslinker.

In testing for the level of clarity, samples were evaluated on black sponge EPDM profile. Samples of a prior art coating from Acheson Colloids Company, Port Huron, Mich., believed to be Acheson TW084 which is believed to be a urethane-silicone-acrylic based coating, were also obtained and evaluated. It was found that the prototype coatings provided lower delta E values (below 2.0) than the competitive Acheson coating.

| Coating | L* | a* | b* | Delta E |
|---|---|---|---|---|
| None (Bare | 25.06 | −0.34 | −1.15 | NA |
| Rubber) | | | | |
| Prior Art | 27.94 | −0.18 | −0.37 | 2.99 |
| Formulation | | | | |
| Formulation A | 25.82 | −0.07 | −0.40 | 1.10 |
| Formulation B | 26.97 | −0.12 | −0.68 | 1.98 |

The delta E values of the coatings can be impacted by the dry film thickness of the coating. Target dry film thickness for the prototype coatings is 0.4-0.6 mils. Performance properties of Formulation B have also been tested per selected portions of the GMN11018 specification developed by General Motors for testing weatherstrip coatings. The results can be seen below:

| GMN11018 Criteria | Result |
|---|---|
| 3.13 Ice Release | Pass - 3.3N |
| 3.20 Low Temp. Flexibility | Pass - No Cracking Observed |
| 3.23 Heat Aging | Pass - No gloss loss, delta E = 1.32 |
| 3.24 Humidity | Pass - No gloss loss, delta E = 2.07 |
| 3.27 Chemical Resistance | |
| (GMN10029) | |
| Windex | Pass - 5 |
| Fantastic | Pass - 5 |
| Formula 409 | Pass - 5 |
| Armor All Cleaner | Pass - 5 |

### GMN11018 Section 3.25—Weathering

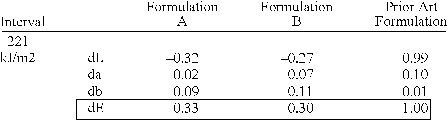

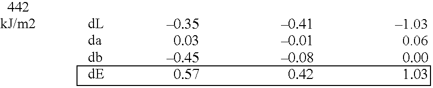

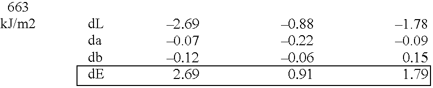

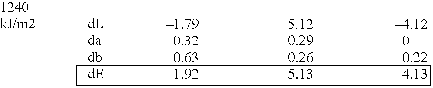

It is believed that the high delta E value obtained with Formulation B following 1240 kJ/m2 of weathering exposure is due to high coating film thickness. It was found to be 0.8 mils; recommended film thickness is 0.4-0.6 mils.

### GMN11018 Section 3.19—Squeak and Itch Testing

### Per GM9842P, Revision D

Random Vibration

| | |
|---|---|
| Dry Interface | Wet Interface |

| | Time | Sones | Notes | Sones | Notes |
|---|---|---|---|---|---|
| Formulation | 0′ | 0.5 | quiet | 0.7 | quiet |
| B | 2′ | 0.5 | quiet | 0.7 | quiet |
| | 4′ | 0.6 | quiet | 0.8 | quiet |
| Maximum | | 0.6 | | 0.8 | |
| Formulation | 0′ | 0.5 | quiet | 0.5 | quiet |
| C | 2′ | 0.5 | quiet | 0.6 | quiet |
| | 4′ | 0.5 | quiet | 0.6 | quiet |
| Maximum | | 0.5 | | 0.6 | |
| Prior Art | 0′ | 0.5 | quiet | 0.8 | quiet |
| | 2′ | 0.4 | quiet | 1.3 | squeak |
| | 4′ | 0.4 | quiet | 1.2 | squeak |
| Maximum | | 0.5 | | 1.3 | |

The data obtained meets, and in some cases exceeds, the results that are typically achieved with traditional black weatherstrip functional coatings. The benefits that are observed over the prior art coating are increased clarity, potentially enhanced weathering performance, and lower noise in terms of squeak and itch testing. The main benefit that is observed with this invention over the traditional black weatherstrip coatings is that co-extrusions containing various colors can be coated without masking the colored portion. Also, if weatherstrip manufacturers are color matching their current compounds to OEM color standards, they can inventory one colorless coating system for all production parts rather than having multiple coatings that are individually color matched.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

What is claimed is:

1. A coating composition comprising a polycarbonate-based polyurethane, and a polyester-based polyurethane, which is substantially free of siloxane compounds, wherein when the coating composition is applied to a substrate, dried, and crosslinked, it has a delta E of less than 3.0 after exposure to 1240 kJ/m2 of ultraviolet light.

2. The coating of claim 1, further comprising a polyethylene wax.

3. The coating composition of claim 1, wherein the polyethylene wax comprises an average particle size of less than 20 μm.

4. The coating composition of claim 1, wherein the delta E is less than 2.0.

5. The coating composition of claim 1, further comprising ceramic spheres.

6. The coating composition of claim 1, further comprising a surfactant.

7. The coating composition of claim 6, wherein the surfactant comprises a fluoro surfactant.

8. The coating composition of claim 1, wherein the polycarbonate-based polyurethane comprises the reaction product of poly(1,6-hexanediol)carbonate, polyethylene glycol and isophorone diisocyanate.

9. The coating composition of claim 1, wherein the coating is crosslinked with a carbodiamide crosslinker.

10. The coating composition of claim 1, wherein the carbodiamide crosslinker is added at about 2.5 weight percent based on the weight of the coating composition.

11. The coating composition of claim 1, wherein the coating is applied to a substrate to a thickness of less than 0.6 mils.

12. The coating composition of claim 1, wherein the substrate comprises EPDM.

13. A coating composition consisting essentially of a polycarbonate-based polyurethane, a polyester-based polyurethane, a polyethylene wax, fumed silica, ceramic spheres, and a surfactant.

14. An article coated with an aqueous polyurethane coating, wherein the dried coating comprises:
30-80 weight percent of a polyurethane mixture comprising at least one polycarbonate-based polyurethane and at least one polyester-based polyurethane;
0.1-10 weight percent fumed silica;
0.1-30 weight percent ceramic spheres having an average particle size of less than 20 μm;
0.1 to 15 weight percent polyethylene wax,
0.1 to 5.0 weight percent of a surfactant;
0.1 to 5.0 weight percent of a UV absorber; and,
0 to 5.0 weight percent of a thickener.
